(19) United States
(12) Patent Application Publication
(10) Pub. No.: US 2017/0349145 A1
(43) Pub. Date: Dec. 7, 2017

(54) SPEECH RECOGNITION TO CONTROL DOOR OR LOCK OF VEHICLE WITH DIRECTIONAL MICROPHONE

(71) Applicants: TRANSTRON INC., Yokohama-shi (JP); HONDA MOTOR CO., LTD., Tokyo (JP)

(72) Inventors: Katsuya TANABE, Kawasaki (JP); Masashi TAMURA, Hino (JP); Junichi WATANABE, lnagi (JP); Hisao KAMODA, Gyoda (JP); Kenichiro Kagawa, Wako (JP); Masaki WATANABE, Wako (JP); Toshihiro KANEDA, Wako (JP); Hiroshi SHINGU, Wako (JP); Makoto ONO, Wako (JP); Satoshi KATAYAMA, Wako (JP)

(73) Assignees: TRANSTRON INC., Yokohama-shi (JP); HONDA MOTOR CO., LTD., Tokyo (JP)

(21) Appl. No.: 15/174,218

(22) Filed: Jun. 6, 2016

(51) Int. Cl. B60R 25/25; E05F 15/73; G10L 15/28; G10L 15/22; B60J 5/06; G10L 15/08

(52) U.S. Cl. CPC B60R 25/257; E05F 15/73; G10L 15/28; E05Y 2400/85; B60J 5/06; G10L 2015/088; G10L 2015/223; E05Y 2900/531

(57) ABSTRACT

An opening/closing control apparatus includes a directional microphone having a sound collecting device disposed on a vehicle and configured to collect sound outside the vehicle. The directional microphone further has directivity upward from a horizontal plane that includes a mounting position of the sound collecting device. The opening/closing control apparatus further includes a control circuit configured to control operation of one of a door and a lock of the vehicle, based on a recognition result obtained by performing speech recognition with respect to an audio signal detected by the directional microphone.

### CROSS REFERENCE TO RELATED APPLICATIONS

This application is based upon and claims the benefit of priority of the prior Japanese Patent Application No. 2015-045843, filed on Mar. 9, 2015, the entire contents of which are incorporated herein by reference.

### FIELD

The embodiments discussed herein are related to an opening/closing control apparatus, a computer product, and opening/closing control method.

### BACKGROUND

Conventionally, there are techniques of controlling the opening and closing of sliding doors on vehicles by speech recognition such as when a user says “open” or “close”. For example, a related technique reduces the effects of noise near a vehicle when recognition of verbal commands from the user is performed to control vehicular functions. For example, refer to Japanese Laid-Open Patent Publication No. 2008-037419.

Nonetheless, with conventional techniques of opening and closing vehicular doors by voice activation, the door may be operated unintentionally when a person says a particular word such as “open”.

### SUMMARY

According to an aspect of an embodiment, an opening/closing control apparatus includes a directional microphone having a sound collecting device disposed on a vehicle and configured to collect sound outside the vehicle. The directional microphone further has directivity upward from a horizontal plane that includes a mounting position of the sound collecting device. The opening/closing control apparatus further includes a control circuit configured to control operation of one of a door and a lock of the vehicle, based on a recognition result obtained by performing speech recognition with respect to an audio signal detected by the directional microphone.

The object and advantages of the invention will be realized and attained by means of the elements and combinations particularly pointed out in the claims

It is to be understood that both the foregoing general description and the following detailed description are exemplary and explanatory and are not restrictive of the invention.

### BRIEF DESCRIPTION OF DRAWINGS

FIGS. 1A, 1B, and 1C are diagrams of an example of an opening/closing control apparatus 101 according a first embodiment;

FIG. 2 is a diagram of an example of control by the opening/closing control apparatus 101 according to the first embodiment;

FIG. 3 is a diagram of another example of control by the opening/closing control apparatus 101 according to the first embodiment;

FIG. 4 is a diagram of an example of hardware configuration of the opening/closing control apparatus 101;

FIG. 5 is a diagram of one example of contents of a command table 500;

FIG. 6 is a block diagram of an example a functional configuration of the opening/closing control apparatus 101 according to the first embodiment;

FIG. 7 is a flowchart of an example of an opening/closing control process procedure according to the first embodiment;

FIG. 8 is a block diagram of a functional configuration of the opening/closing control apparatus 101 according to a second embodiment;

FIG. 9 is a diagram of an example of entry sensing information 900;

FIG. 10 is a diagram of an example of control by the opening/closing control apparatus 101 according to the second embodiment;

FIG. 11 is a diagram of another example of control by the opening/closing control apparatus 101 according to the second embodiment;

FIG. 12 is a flowchart of an example of an updating process procedure according to the second embodiment;

FIG. 13 is a flowchart of an example of the opening/closing control process procedure according to the second embodiment;

FIG. 14 is a block diagram of a functional configuration of the opening/closing control apparatus 101 according to a third embodiment;

FIG. 15 is a diagram of an example of person detection information 1500;

FIG. 16 is a diagram of an example of control by the opening/closing control apparatus 101 according to the third embodiment;

FIG. 17 is a diagram of another example of control by the opening/closing control apparatus 101 according to the third embodiment;

FIG. 18 is a flowchart of an example of the updating process procedure according to the third embodiment; and

FIG. 19 is a flowchart of an example of the opening/closing control process procedure according to the third embodiment.

### DESCRIPTION OF THE INVENTION

Embodiments of an opening/closing control apparatus, opening/closing control program, and an opening/closing control method will be described in detail with reference to the accompanying drawings.

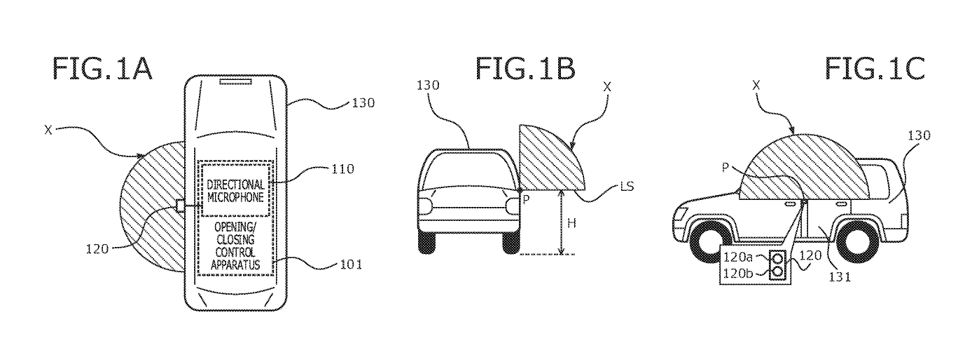

FIGS. 1A, 1B, and 1C are diagrams of an example of an opening/closing control apparatus 101 according a first embodiment. In FIGS. 1A, 1B, and 1C, the opening/closing control apparatus 101 is a computer that is equipped on a vehicle and configured to control operation of a door or a lock of the vehicle. In particular, the opening/closing control apparatus 101 includes a directional microphone 110 and operates a door or lock on the vehicle, based on recognition results obtained by speech recognition with respect to an audio signal of sound detected by the directional microphone 110.

The vehicle is, for example, an automobile such as a passenger vehicle, a truck, a bus, or the like. A lock of the vehicle is a door lock for locking and unlocking a door of the vehicle, and is configured to enable locking and unlocking by remote operation. A door of the vehicle is a door configured to be opened and closed by remote operation and is, for example, a sliding door, a cargo access door, and the like. A sliding door is a door that opens and closes parallel to the body of the vehicle. A cargo access door is a door to cargo space (e.g., trunk, hatchback, etc.) of the vehicle.

Electronic key systems are present that enable the operation of vehicular doors and locks by remote operation using an electronic key. Such systems enable vehicular doors and locks to be operated by user operation of an electronic key. Nonetheless, when both hands of the user are occupied, such as when carrying items, operation of the electronic key becomes difficult and convenience decreases.

Therefore, use of speech recognition to control the operation of vehicular doors and locks is conceivable. In this case, even when both hands of the user are occupied, a door or lock of the vehicle can be opened by a mere utterance of “open”, for example. However, when a door or lock of the vehicle is operated by voice activation and a particular word such as “open” is spoken by a child or used in a conversion by people away from the vehicle, unintended opening or closing of a door may occur.

Thus, in the first embodiment, an opening/closing control method of using the directivity of the directional microphone 110 equipped on the opening/closing control apparatus 101 to limit the operator capable of operating vehicular doors and locks by voice activation will be described.

In particular, the directional microphone 110 has a sound collecting unit 120 that is disposed on the vehicle and collects external sounds outside the vehicle. The sound collecting unit 120 is disposed at a position at a predetermined height H of the vehicle. In the example depicted in FIGS. 1A, 1B, and 1C, the sound collecting unit 120 includes two microphones 120a, 120b and is disposed at a position at the predetermined height H near a sliding door 131 of a vehicle 130.

The directional microphone 110 has directivity upward from a horizontal plane that includes a mounting position P of the sound collecting unit 120. In the example depicted in FIGS. 1A, 1B, and 1C, the directional microphone 110 is an array of microphones capable of controlling directivity so that sensitivity increases for sound coming from a specific range extending upward from a horizontal plane LS that includes the mounting position P of the sound collecting unit 120.

In the description hereinafter, the specific range extending upward from a horizontal plane LS that includes the mounting position P of the sound collecting unit 120 may be indicated as “directivity range X”. The directivity range X, for example, is set so as to include the height of the mouth of an average adult. FIG. 1A depicts the directivity range X as viewed from above the vehicle 130; FIG. 1B depicts the directivity range X as viewed from a front of the vehicle 130; and FIG. 1C depicts the directivity range X as viewed from a side the vehicle 130.

With the opening/closing control apparatus 101, when a person speaks outside the directivity range X, detection of the audio signal by the directional microphone 110 becomes difficult. Thus, the opening/closing control apparatus 101 prevents the doors and locks of the vehicle 103 from being operated by the recognition of speech coming from a position outside the directive range X.

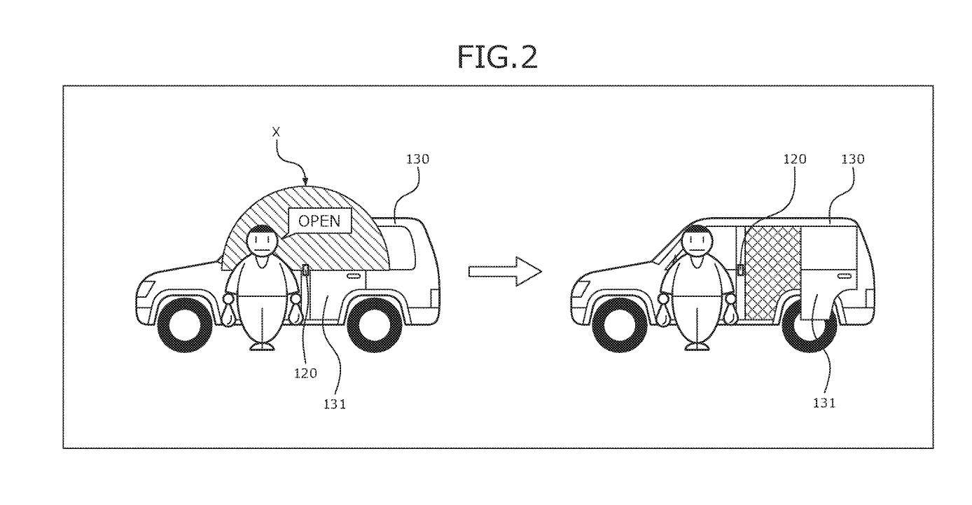

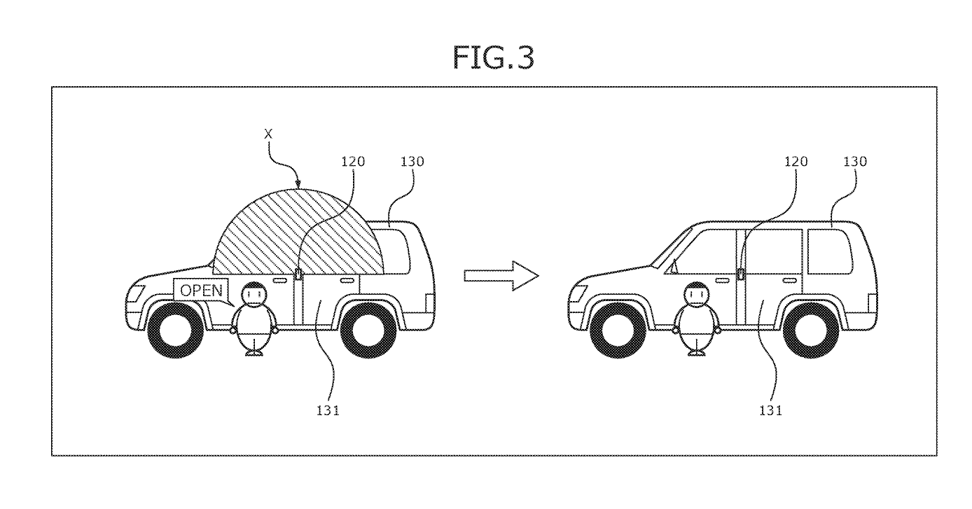

Control by the opening/closing control apparatus 101 according to the first embodiment will be described with reference to FIGS. 2 and 3, taking a case of controlling operations of opening and closing the sliding door 131 of the vehicle 130 as an example.

FIG. 2 is a diagram of an example of control by the opening/closing control apparatus 101 according to the first embodiment. In FIG. 2, the user is assumed to say “open” within the directivity range X. In this case, the opening/closing control apparatus 101 detects the utterance and performs speech recognition. The opening/closing control apparatus 101 performs control of opening the sliding door 131, based on the recognition results (open) obtained by the speech recognition.

As a result, even when both hands of the user are occupied such as when carrying items, the sliding door 131 of the vehicle 130 can be opened by a mere utterance of “open” within the directivity range X.

FIG. 3 is a diagram of another example of control by the opening/closing control apparatus 101 according to the first embodiment. In FIG. 3, the user is assumed to say “open” outside the directivity range X. The user is a child whose height is less than the predetermined height H. In this case, the utterance by the child is a sound coming from outside the directivity range X and therefore, is not detected by the opening/closing control apparatus 101. As a result, the utterance by the child is not recognized and control of opening the sliding door 131 is not performed.

Thus, according to the opening/closing control apparatus 101 of the first embodiment, directivity is imparted to the directional microphone 110 and by adjusting the height H of the position where the sound collecting unit 120 is disposed, operators capable of operating vehicular doors and locks by voice activation can be limited. As a result, a person of a height less than the height H, such as a child, can be prevented from operating doors and locks of the vehicle 130 by voice activation.

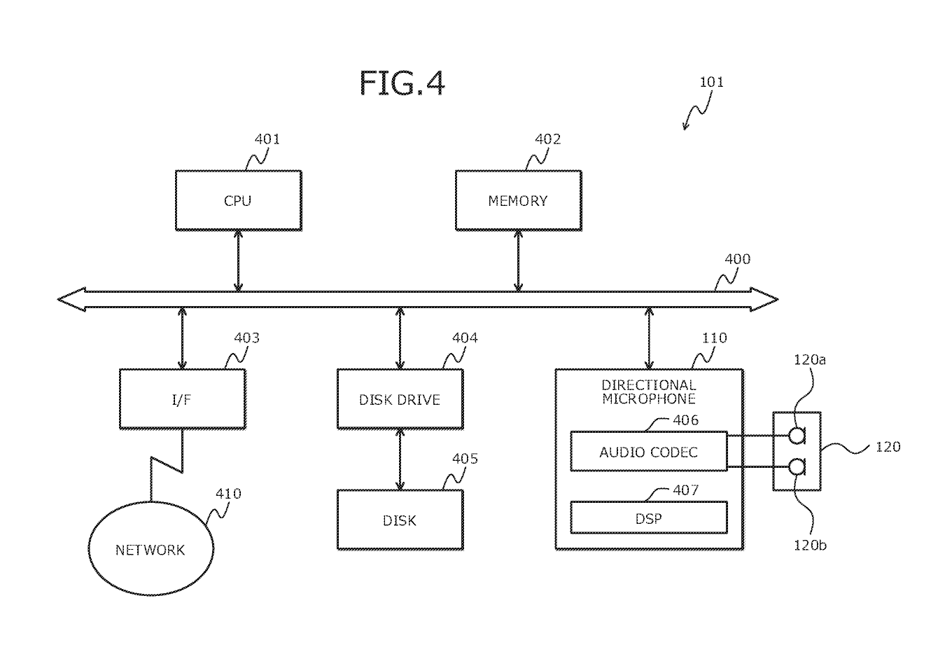

FIG. 4 is a diagram of an example of hardware configuration of the opening/closing control apparatus 101. In FIG. 4, the opening/closing control apparatus 101 includes a central processing unit (CPU) 401, a memory 402, an interface (I/F) 403, a disk drive 404, a disk 405, and the directional microphone 110, respectively connected by a bus 400.

Here, the CPU 401 governs overall control of the opening/closing control apparatus 101. The memory 402, for example, includes read-only memory (ROM), random access memory (RAM), flash ROM, and the like. In particular, for example, the flash ROM and ROM store various types of programs; and the RAM is used as a work area of the CPU 401. Programs stored by the memory 402 are loaded onto the CPU 401, whereby encoded processes are executed by the CPU 401.

The I/F 403 is connected to a network 410, via a communications line, and is connected to other computers through the network 410. The I/F 403 administers an internal interface with the network 410, and controls the input and output of data from other computers. The I/F 403, for example, may be a modem, a network interface card (NIC), or the like.

The disk drive 404, under the control of the CPU 401, controls the reading and writing of data with respect to the disk 405. The disk 405 stores data written thereto under the control of the disk drive 404. The disk 405, for example, may be a magnetic disk, an optical disk, and the like.

The directional microphone 110 includes the sound collecting unit 120 having the microphones 120a, 120b; an audio codec 406; and a digital signal processor (DSP) 407. The audio codec 406, for example, includes an analog/digital (A/D) converter, an amplifier, D/A converter, and the like. The DSP 407 is a processor configured to perform digital signal processing.

Among the described components, the opening/closing control apparatus 101, for example, may omit the disk drive 404 and the disk 405.

Contents of a command table 500 used by the opening/closing control apparatus 101 will be described. The command table 500, for example, is stored in a storage device such as the memory 402 and the disk 405 depicted in FIG. 4.

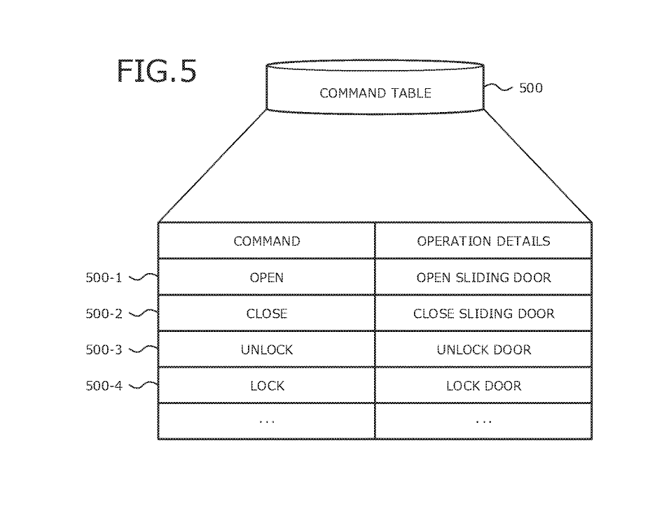

FIG. 5 is a diagram of one example of the contents of the command table 500. In FIG. 5, the command table 500 has fields for commands and operation details. Information is set into the respective fields, whereby command information (for example, command information 500-1 to 500-4) is stored as records.

Herein, a command represents a command for instructing the opening or closing of a door, or the locking or unlocking of a lock of the vehicle 130 (refer to FIGS. 1A, 1B, and 1C). Operation details represent operation details of the vehicle 130 corresponding to a command. For example, the command information 500-1 that operation details “open sliding door” of the vehicle 130 correspond to a command “open”.

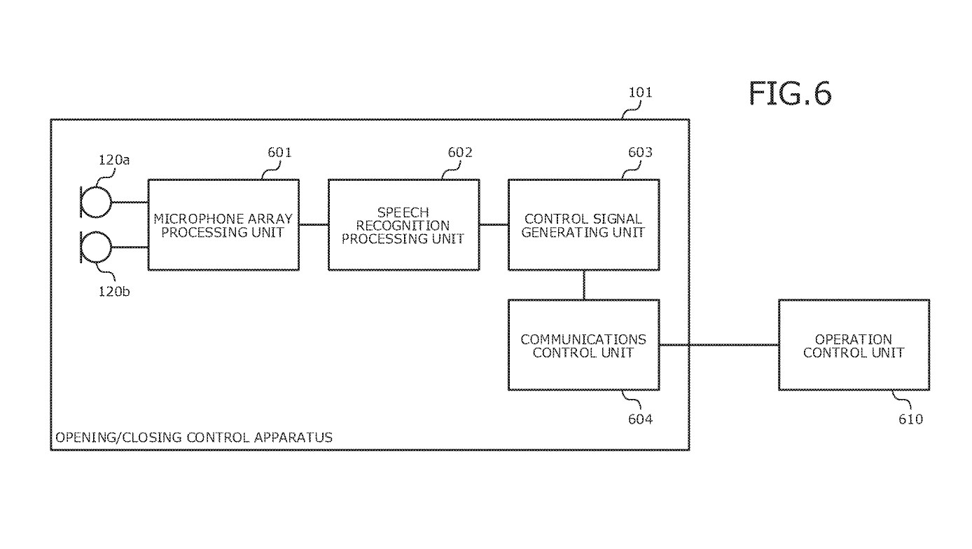

FIG. 6 is a block diagram of an example a functional configuration of the opening/closing control apparatus 101 according to the first embodiment. In FIG. 6, the opening/closing control apparatus 101 is configured to include a microphone array processing unit 601, a speech recognition processing unit 602, a control signal generating unit 603, and a communications control unit 604. The microphone array processing unit 601, for example, is implemented by the audio codec 406 and the DSP 407 of the directional microphone 110 depicted in FIG. 4. Further, the speech recognition processing unit 602 to the communications control unit 604 are functions forming a control unit and, for example, are implemented by executing on the CPU 401, a program stored by a storage device such as the memory 402 or the disk 405 depicted in FIG. 4, or by the I/F 403. Processing results of the functional units, for example, are stored to a storage device such as the memory 402 and the disk 405.

The microphone array processing unit 601 detects an audio signal having directivity upward from a horizontal plane that includes the mounting position of the sound collecting unit 120. In the description hereinafter, as depicted in FIGS. 1A, 1B, and 1C, a case where the sound collecting unit 120 is disposed at the mounting position P of the predetermined height H, near the sliding door 131 of the vehicle 130 will be described as an example.

In particular, for example, the microphone array processing unit 601 amplifies by the audio codec 406, an analog signal of sound collected by the microphones 120a, 120b, and generates a digital audio signal. The microphone array processing unit 601, for example, by the DSP 407, corrects the generated audio signal such that the sensitivity for sound from the directivity range X (refer to FIGS. 1A, 1B, and 1C) becomes higher.

Here, the distance between a speaker and the respective microphones 120a, 120b varies according to the position (height of the mouth) of the speaker. Therefore, a temporal difference T determined by the speed of sound and the distance between the speaker and the microphones 120a, 120b arises in the sound collected by the microphones 120a, 120b.

The microphone array processing unit 601, for example, by the DSP 407, detects the temporal difference T and corrects the generated audio signal by suppressing sounds for which the temporal difference T is outside a predetermined range. In other words, the microphone array processing unit 601 adjusts the predetermined range, which is compared to the temporal difference T, and thereby controls the range of directivity.

As a result, audio signals having directivity that is upward from the horizontal plane LS that includes the mounting position P of the sound collecting unit 120 are detected. Concerning a technique of controlling directivity of microphones, for example, Japanese Laid-Open Patent Publication No. 2007-318528 may be referred to.

The speech recognition processing unit 602 performs speech recognition with respect to audio signals detected by the microphone array processing unit 601. In particular, for example, the speech recognition processing unit 602 analyzes a detected audio signal at constant intervals to detect a speech section that includes speech. When detecting a speech section, the speech recognition processing unit 602 performs speech recognition processing with respect to the audio signal having the speech section.

Based on a recognition result indicating speech recognized by the speech recognition processing unit 602, the control signal generating unit 603 generates a control signal that controls the opening or closing of a door, or the locking or unlocking of a lock of the vehicle. In particular, for example, the control signal generating unit 603 refers to the command table 500 depicted in FIG. 5 and identifies the command that corresponds to the recognition result indicating recognized speech. The control signal generating unit 603 subsequently identifies the vehicular operation details that correspond to the identified command. The control signal generating unit 603 generates a control signal corresponding to the identified vehicular operation details.

For example, “open” is assumed to be recognized by speech recognition. In this case, the control signal generating unit 603 refers to the command table 500 and identifies a command “open”. The control signal generating unit 603 identifies the operation details “open sliding door” corresponding to the identified command. The control signal generating unit 603 generates a control signal instructing an operation having the identified operation details “open sliding door”.

Further, for example, “unlock” is assumed to be recognized by speech recognition. In this case, the control signal generating unit 603 refers to the command table 500 and identifies a command “unlock”. The control signal generating unit 603 subsequently identifies the operation details “unlock door” corresponding to the identified command “unlock”. The control signal generating unit 603 then generates a control signal instructing an operation having the identified operation details “unlock door”.

The communications control unit 604 transmits the generated control signal to an operation control unit 610 that controls operations of the vehicle 130. The operation control unit 610, for example, is an electronic control unit (ECU) that performs electronic control of the vehicle 130. The operation control unit 610 controls the operation of the vehicle 130 according to the control signal from the communications control unit 604.

For example, when receiving a control signal instructing an operation having the operation details “open sliding door”, the operation control unit 610 opens the sliding door 131 of the vehicle 130. Further, for example, when receiving a control signal instructing an operation having the operation details “unlock door”, the operation control unit 610 unlocks a door lock of the vehicle 130.

In the example depicted in FIG. 6, although a case has been described where the operation control unit 610 is disposed separately from the opening/closing control apparatus 101, the operation control unit 610 may be included in the opening/closing control apparatus 101. In this case, the operation control unit 610, for example, is implemented by executing on the CPU 401, a program stored in a storage device such as the memory 402 and the disk 405, or by the I/F 403.

Further, in the description above, although a case where directivity is controlled by correcting the sound collected by the microphones 120a, 120b, configuration is not limited hereto. For example, the directional microphone 110 may be of a structure that increases the sensitivity for sound from the directivity range X, by physically limiting that the path by which sound enters the microphone, such as horn type or parabolic microphone.

An opening/closing control process procedure of the opening/closing control apparatus 101 according to the first embodiment will be described.

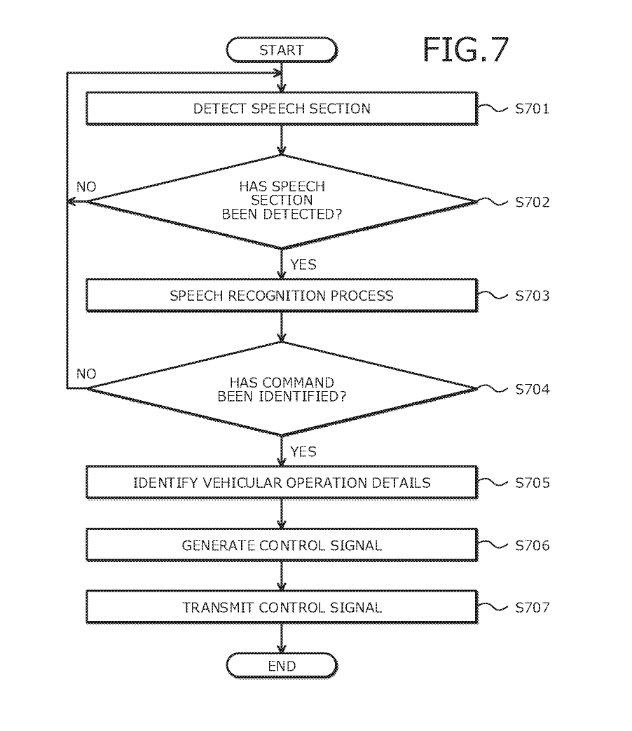

FIG. 7 is a flowchart of an example of the opening/closing control process procedure of the opening/closing control apparatus 101 according to the first embodiment. In the flowchart depicted in FIG. 7, the speech recognition processing unit 602 analyzes an audio signal detected by the microphone array processing unit 601, the speech recognition processing unit 602 analyzing the audio signal at a constant interval to detect a speech section including speech, (step S701).

The speech recognition processing unit 602 determines whether a speech section has been detected (step S702). If no speech section has been detected (step S702: NO), the speech recognition processing unit 602 returns to step S701. On the other hand, if a speech section has been detected (step S702: YES), the speech recognition processing unit 602 performs speech recognition processing with respect to the audio signal having the detected speech section (step S703).

The control signal generating unit 603 refers to the command table 500 and identifies a command that corresponds to the speech recognized by the speech recognition processing unit 602, indicated by the recognition result (step S704). If no command corresponding to the recognition result is identified (step S704: NO), the control signal generating unit 603 returns to step S701.

If a command corresponding to the recognition result is identified (step S704: YES), the control signal generating unit 603 refers to the command table 500 and identifies the vehicular operation details that correspond to the identified command (step S705). The control signal generating unit 603 generates a control signal corresponding to the identified vehicular operation details (step S706).

The communications control unit 604 transmits the control signal generated by the control signal generating unit 603 to the operation control unit 610, which controls operations of the vehicle 130 (step S707), ending a series of operations according to the flowchart.

Thus, the operation control unit 610 (for example, the ECU of the vehicle 130) can be instructed to perform an operation corresponding to a recognition result obtained by performing speech recognition with respect to an audio signal detected by the directional microphone 110.

As described, the opening/closing control apparatus 101 according to the first embodiment enables the opening or closing of a door, or the locking or unlock of a lock of the vehicle 130 to be controlled based on a recognition result obtained by performing speech recognition with respect to an audio signal detected by the directional microphone 110. As a result, the operator capable of operating doors and locks of the vehicle 130 by voice activation can be limited by adjusting the height H of the position where the sound collecting unit 120, which collects sound outside the vehicle 130, is disposed.

For example, by setting the height H of the position where the sound collecting unit 120 is disposed to be about 1 m, the speech of a child whose height is less than 1 m becomes difficult to recognize, enabling a configuration in which the doors and locks of the vehicle 130 cannot be voice activated by a child.

The opening/closing control apparatus 101 according to a second embodiment will be described. Portions identical to those of the first embodiment are given the same reference numerals used in the first embodiment and will not be redundantly described.

When door and lock operations are performed by voice activation, even a person who is not the owner of the vehicle 130 becomes capable of the opening and closing doors and the locking and unlocking locks of the vehicle 130, inviting decreased security. Thus, in the second embodiment, a case of further limiting the operator capable of operating vehicular doors and locks by voice activation, to a user carrying an electronic key K (i.e., smart key) of the vehicle 130 will be described.

An example of a functional configuration of the opening/closing control apparatus 101 according to the second embodiment will be described.

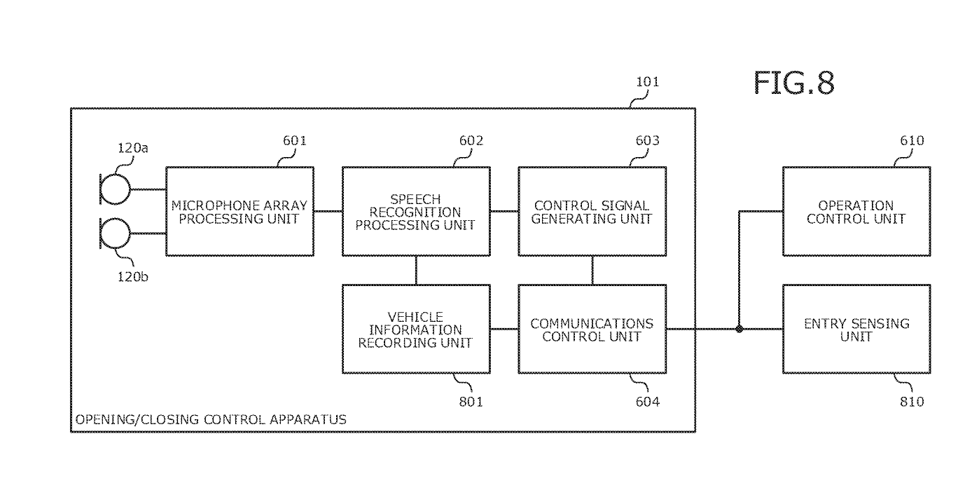

FIG. 8 is a block diagram of a functional configuration of the opening/closing control apparatus 101 according to the second embodiment. In FIG. 8, the opening/closing control apparatus 101 is configured to include the microphone array processing unit 601, the speech recognition processing unit 602, the control signal generating unit 603, the communications control unit 604, and a vehicle information recording unit 801. The microphone array processing unit 601, for example, is implemented by the audio codec 406 and the DSP 407 of the directional microphone 110 depicted in FIG. 4. Further, the speech recognition processing unit 602 to the communications control unit 604, and the vehicle information recording unit 801 are functions forming a control unit and, for example, are implemented by executing on the CPU 401, a program stored in a storage device such as the memory 402 and the disk 405 depicted in FIG. 4, or the I/F 403. Processing results of the functional units, for example, are stored to storage device such as the memory 402 and the disk 405.

The communications control unit 604 receives from an entry sensing unit 810, an entry sensing signal indicating entry of the electronic key K into an effective range (hereinafter, “effective range Y”). The communications control unit 604 further receives from the entry sensing unit 810, an exit sensing signal indicating that the electronic key K has become outside the effective range Y.

Here, the electronic key K is a key that establishes a state enabling the locking and unlocking of a lock of the vehicle 130 by wireless communication with a communications device equipped on the vehicle 130. For example, when receiving radio waves intermittently transmitted from the communications device of the vehicle 130, the electronic key K transmits an identification (ID) code to the vehicle.

When communications device of the vehicle 130 receives the ID code from the electronic key K, the communications device checks the ID code, via the ECU, etc. If the ID code is determined to be the correct ID code, for example, a lock of the vehicle 130 can be unlocked by a touch sensor or switch disposed on a door handle of the vehicle 130.

In this state, for example, if the touch sensor or switch disposed on the door handle of the vehicle 130 is manipulated, the door of the vehicle 130 is unlocked, via the ECU, etc. The effective range Y of the electronic key K is an area in which radio waves intermittently transmitted from the communications device of the vehicle 130 can be received by the electronic key K and, for example, is set to a range of about 1 to 2 m from the door handle.

The entry sensing unit 810 is a functional unit that senses entry of the electronic key K into the effective range Y and, for example, is implemented by the ECU, etc. of the vehicle 130. In particular, for example, when the ID code received from the electronic key K is determined to be correct, the entry sensing unit 810 transmits to the communications control unit 604, an entry sensing signal indicating entry of the electronic key K into the effective range Y. Further, when wireless communication with the electronic key K for which the ID code has been determined to be correct becomes impossible, the entry sensing unit 810 transmits to the communications control unit 604, an exit sensing signal indicating that the electronic key K has become outside the effective range Y.

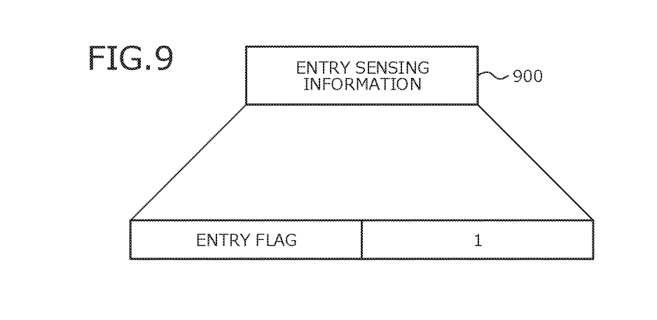

The vehicle information recording unit 801 records the entry sensing signal or exit sensing signal received by the communications control unit 604. In particular, for example, when an entry sensing signal or exit sensing signal is received by the communications control unit 604, the vehicle information recording unit 801 updates entry sensing information 900 as depicted in FIG. 9. Here, an example of the entry sensing information 900 will be described.

FIG. 9 is a diagram of an example of the entry sensing information 900. In FIG. 9, the entry sensing information 900 has an entry flag. The entry flag is information that indicates whether the electronic key K has entered the effective range Y and is “0” in the initial state. The entry sensing information 900, for example, is stored to a storage device such as the memory 402 and the disk 405.

For example, when an entry sensing signal is received by the communications control unit 604, the vehicle information recording unit 801 sets the entry flag to “1”. Further, when an exit sensing signal is received by the communications control unit 604, the vehicle information recording unit 801 sets the entry flag to “0”. The entry flag enables discrimination of whether the electronic key K has entered the effective range Y.

Here, description of FIG. 8 is continued. When an entry sensing signal is received by the communications control unit 604, the speech recognition processing unit 602 performs speech recognition for the audio signal detected by the microphone array processing unit 601. In particular, for example, the speech recognition processing unit 602 refers to the entry sensing information 900 depicted in FIG. 9 and when the entry flag is “1”, the speech recognition processing unit 602 performs speech recognition with respect to the audio signal detected by the microphone array processing unit 601.

On the other hand, when the entry flag is “0”, the speech recognition processing unit 602 refrains from performing speech recognition with respect to the audio signal. As a result, the speech of a person not carrying the electronic key K is not recognized, enabling the operator capable of operating doors and locks of the vehicle 130 by voice activation to be limited to a user carrying the electronic key K, whereby a decrease in security can be prevented.

In the example depicted in FIG. 8, although the operation control unit 610 and the entry sensing unit 810 are described to be disposed separately from the opening/closing control apparatus 101, the operation control unit 610 and the entry sensing unit 810 may be included in the opening/closing control apparatus 101. In this case, the operation control unit 610 and the entry sensing unit 810, for example, are implemented by executing on the CPU 401, a program stored in a storage device such as the memory 402 and the disk 405, or by the I/F 403.

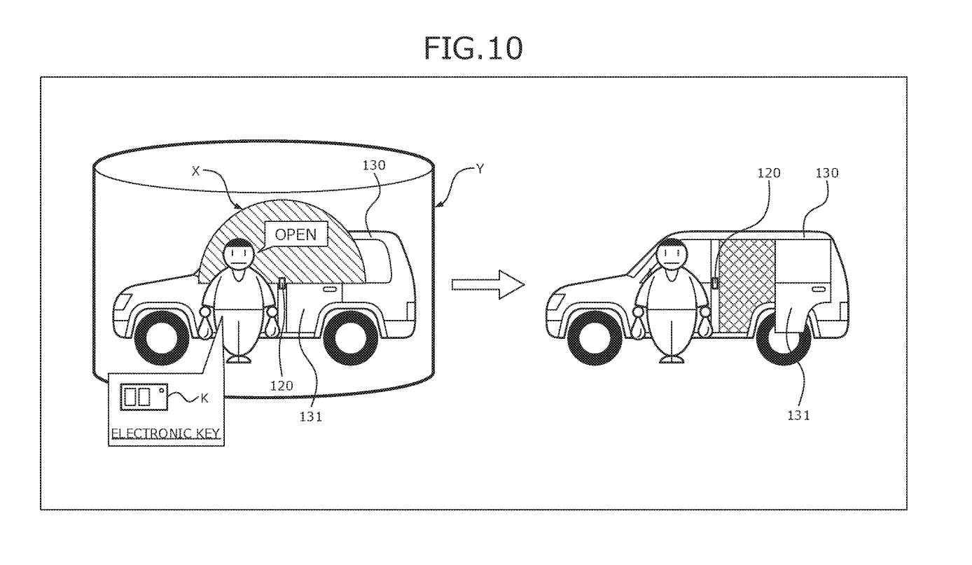

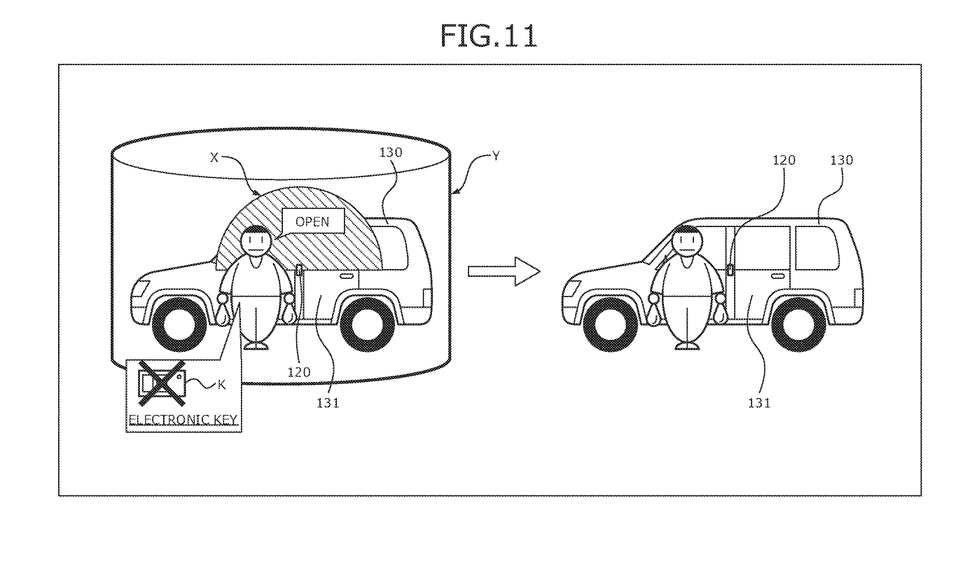

Control by the opening/closing control apparatus 101 according to the second embodiment will be described with reference to FIGS. 10 and 11, taking a case of controlling operations of opening and closing the sliding door 131 of the vehicle 130 as an example.

FIG. 10 is a diagram of an example of control by the opening/closing control apparatus 101 according to the second embodiment. In FIG. 10, a user carrying the electronic key K is assumed to enter the effective range Y of the electronic key K and say “open” within the directivity range X. In this case, since the electronic key K is within the effective range Y, the entry flag of the entry sensing information 900 is “1”.

Therefore, the opening/closing control apparatus 101 detects a speech section and performs speech recognition. The opening/closing control apparatus 101 controls the opening of the sliding door 131, based on a recognition result (open) obtained by the speech recognition. As a result, even if the user carrying the electronic key K is holding an item in both hands, the user can open the sliding door 131 of the vehicle 130 by merely saying “open” within the directivity range X.

FIG. 11 is a diagram of another example of control by the opening/closing control apparatus 101 according to the second embodiment. In FIG. 11, the user, who is not carrying the electronic key K, is assumed to enter the effective range Y of the electronic key K and say “open” within the directivity range X. In this case, the electronic key K is not within the effective range Y and therefore, the entry flag of the entry sensing information 900 is “0”. Thus, the opening/closing control apparatus 101 does not perform speech recognition.

As a result, when the user is not carrying the electronic key K, even if the user says “open” within the directivity range X, control of opening the sliding door 131 is not performed, preventing a decrease in security.

Various process procedures of the opening/closing control apparatus 101 according to the second embodiment will be described. First, an updating process procedure for the entry sensing information 900 depicted in FIG. 9 will be described.

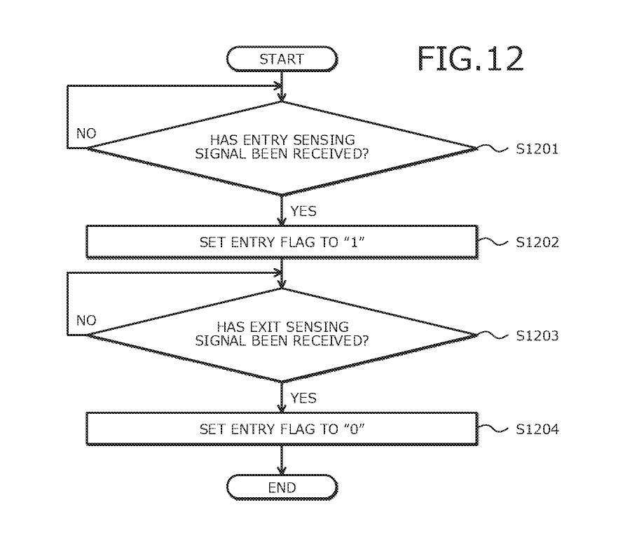

FIG. 12 is a flowchart of an example of the updating process procedure by the opening/closing control apparatus 101 according to the second embodiment. In the flowchart depicted in FIG. 12, the vehicle information recording unit 801 determines whether an entry sensing signal has been received by the communications control unit 604 (step S1201).

The vehicle information recording unit 801 stands by until an entry sensing signal has been received (step S1201: NO). When an entry sensing signal has been received (step S1201: YES), the vehicle information recording unit 801 sets the entry flag of the entry sensing information 900 to “1” (step S1202).

The vehicle information recording unit 801 determines whether an exit sensing signal has been received by the communications control unit 604 (step S1203). The vehicle information recording unit 801 stands by until an exit sensing signal has been received (step S1203: NO).

When an exit sensing signal has been received (step S1203: YES), the vehicle information recording unit 801 sets the entry flag of the entry sensing information 900 to “0” (step S1204), ending a series of operations according to the flowchart. Thus, the entry flag indicating whether the electronic key K has entered the effective range Y is updated.

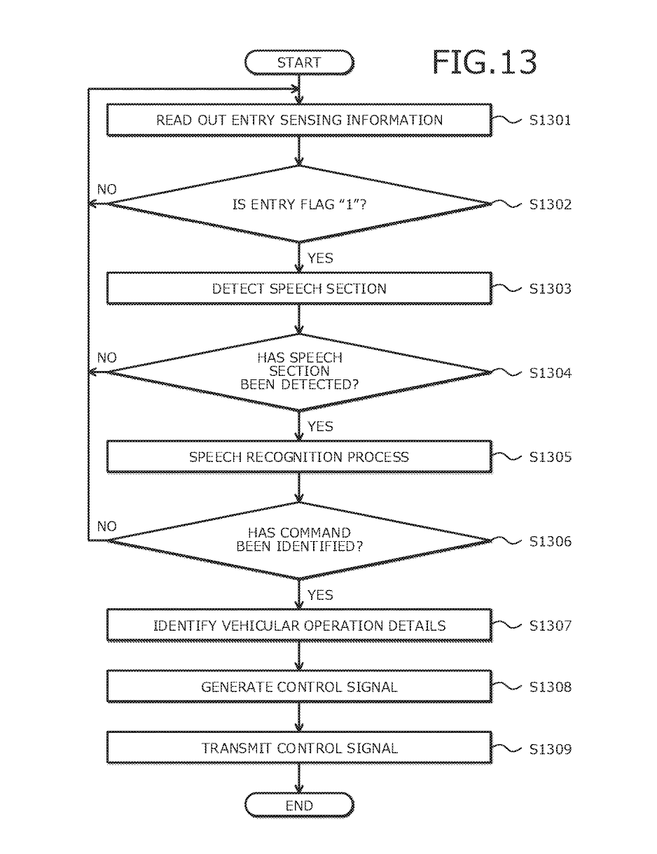

FIG. 13 is a flowchart of an example of the opening/closing control process procedure by the opening/closing control apparatus 101 according to the second embodiment. In the flowchart depicted in FIG. 13, the speech recognition processing unit 602 reads out the entry sensing information 900 (step S1301). The speech recognition processing unit 602 determines whether the entry flag of the entry sensing information 900 is “1” (step S1302).

If the entry flag is “0” (step S1302: NO), the speech recognition processing unit 602 returns to step S1301. If the entry flag is “1” (step S1302: YES), the speech recognition processing unit 602 analyzes the audio signal detected by the microphone array processing unit 601, the speech recognition processing unit 602 analyzing the audio signal at a constant interval to detect a speech section including speech (step S1303).

The speech recognition processing unit 602 determines whether a speech section has been detected (step S1304). If no speech section has been detected (step S1304: NO), the speech recognition processing unit 602 returns to step S1301. If a speech section has been detected (step S1304: YES), the speech recognition processing unit 602 performs speech recognition processing with respect to the audio signal having the detected speech section (step S1305).

The control signal generating unit 603 refers to the command table 500 and identifies a command that corresponds to the speech recognized by the speech recognition processing unit 602, indicated by the recognition result (step S1306). Here, if no command corresponding to the recognition result is identified (step S1306: NO), the control signal generating unit 603 returns to step S1301.

On the other hand, if a command corresponding to the recognition result is identified (step S1306: YES), the control signal generating unit 603 refers to the command table 500 and identifies the vehicular operation details that correspond to the identified command (step S1307). The control signal generating unit 603 generates a control signal corresponding to the identified vehicular operation details (step S1308).

The communications control unit 604 transmits the control signal generated by the control signal generating unit 603 to the operation control unit 610, which controls operations of the vehicle 130 (step S1309), ending a series of operations according to the flowchart.

Thus, when a user carrying the electronic key K is present in the effective range Y, speech recognition for the audio signal detected by the directional microphone 110 can be started.

As described, according to the opening/closing control apparatus 101 of the second embodiment, when entry of the electronic key K into the effective range Y has been detected, speech recognition for the audio signal detected by the directional microphone 110 can be performed. As a result, the operator capable of operating doors and locks of the vehicle 130 by voice activation is limited to a user carrying the electronic key K of the vehicle 130, preventing a decrease in security.

The opening/closing control apparatus 101 according to a third embodiment will be described. Portions identical to those of the first and second embodiments are given the same reference numerals used in the first and second embodiments, and will not be redundantly described.

When a person near the vehicle 130 is talking loudly, even if the person is outside the directivity range X, the speech recognition processing unit 602 may detect a speech section and perform speech recognition. In this case, if the person near the vehicle 130 says a word such as “open” loudly, control of opening the sliding door 131 of the vehicle 130 may be performed.

Thus, in the third embodiment, a case of further limiting the operator capable of operating doors and locks of the vehicle 130 by voice activation, to a user detected by a person detection sensor S disposed on the vehicle 130 will be described.

An example of a functional configuration of the opening/closing control apparatus 101 according to the third embodiment will be described.

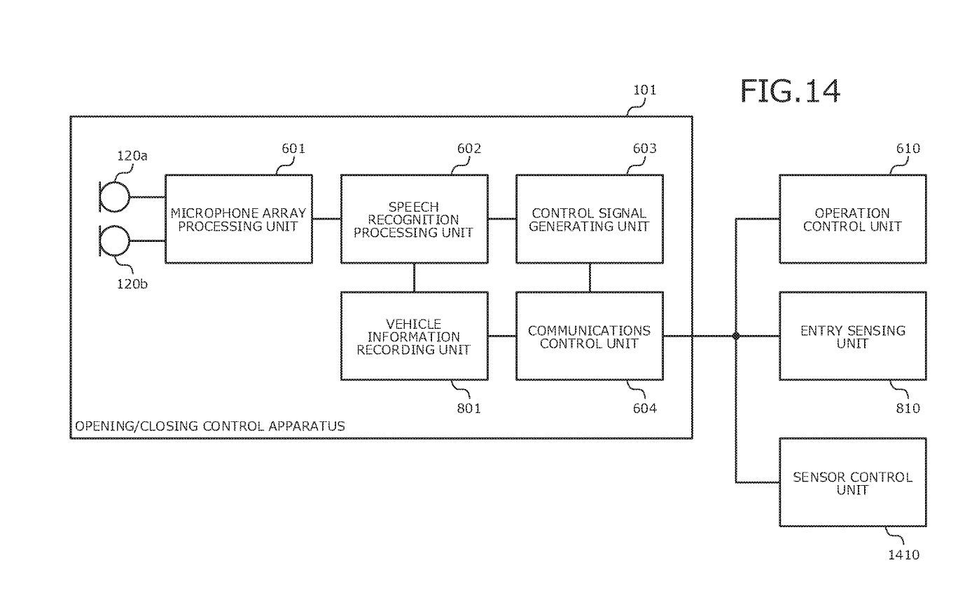

FIG. 14 is a block diagram of a functional configuration of the opening/closing control apparatus 101 according to the third embodiment. In FIG. 14, the opening/closing control apparatus 101 is configured to include the microphone array processing unit 601, the speech recognition processing unit 602, the control signal generating unit 603, the communications control unit 604, and the vehicle information recording unit 801.

The communications control unit 604 receives from a sensor control unit 1410, a person detection signal indicating that a person outside the vehicle 130 has been detected by the person detection sensor S disposed on the vehicle 130. The communications control unit 604 further receives from the sensor control unit 1410, a person non-detection signal indicating that a person outside the vehicle 130 has not been detected by the person detection sensor S.

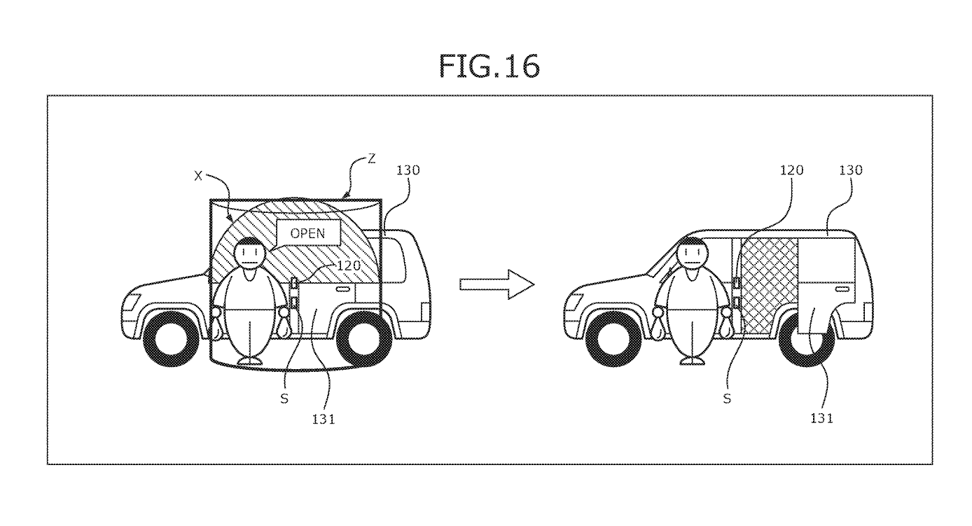

Here, the person detection sensor S is a sensor that detects a person. For example, a device employing an infrared, ultrasonic, image recognition, or similar technology may be used as the person detection sensor S. The person detection sensor S is disposed on the vehicle 130 to detect a person speaking within the directivity range X. Therefore, the person detection sensor S is disposed, for example, near the sliding door 131 of the vehicle 13 (for example, refer to FIG. 16).

A detection range Z of the person detection sensor S is set, for example, within a range of about 50 cm to 1 m from the person detection sensor S.

The sensor control unit 1410 is a functional unit configured to obtain at a constant interval, a detection result of the person detection sensor S and, for example, is implemented by the ECU of the vehicle 130. In particular, for example, when a detection result indicating that a person has been detected is received from the person detection sensor S, the sensor control unit 1410 transmits to the communications control unit 604, a person detection signal indicating that a person outside the vehicle 130 has been detected. Further, when a detection result indicating that a person has not been detected is received from the person detection sensor S, the sensor control unit 1410 transmits to the communications control unit 604, a person non-detection signal indicating that a person outside of the vehicle has not been detected.

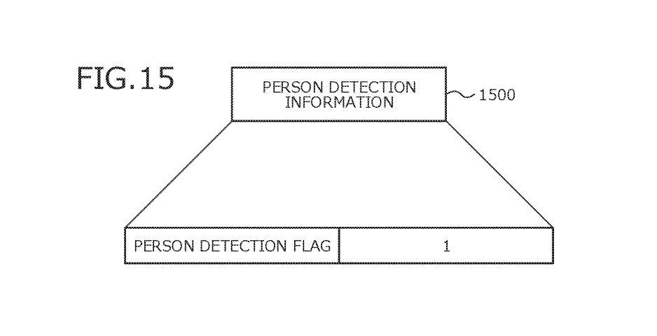

The vehicle information recording unit 801 records the person detection signal or the person non-detection signal received by the communications control unit 604. In particular, for example, when a person detection signal or a person non-detection signal is received by the communications control unit 604, the vehicle information recording unit 801 updates person detection information 1500 such as that depicted in FIG. 15. Here, an example of the person detection information 1500 is described.

FIG. 15 is a diagram of an example of the person detection information 1500. In FIG. 15, the person detection information 1500 has a person detection flag. The person detection flag is information indicating whether a person outside the vehicle 130 has been detected by the person detection sensor S; and is “0” in the initial state. The person detection information 1500, for example, is stored in a storage device such as the memory 402 and the disk 405.

For example, when a person detection signal is received by the communications control unit 604, the vehicle information recording unit 801 sets the person detection flag to “1”. Further, when a person non-detection signal is received by the communications control unit 604, the vehicle information recording unit 801 sets the person detection flag to “0”. The person detection flag enables discrimination of whether a person outside the vehicle 130 has been detected by the person detection sensor S disposed on the vehicle 130.

Here, description of FIG. 14 is continued. When a person detection signal is received by the communications control unit 604, the speech recognition processing unit 602 performs speech recognition for the audio signal detected by the microphone array processing unit 601. In particular, for example, the speech recognition processing unit 602 refers to the person detection information 1500 depicted in FIG. 15 and if the person detection flag is “1”, the speech recognition processing unit 602 performs speech recognition for the audio signal detected by the microphone array processing unit 601.

If the person detection flag is “0”, the speech recognition processing unit 602 refrains from performing speech recognition for the audio signal. As a result, even when a person near the vehicle 130 speaks in a loud voice, speech recognition is not performed if the person is not detected by the person detection sensor S and therefore, unintended operation of a door or lock of the vehicle 130 by the speaker is prevented.

Further, when a person detection signal and an entry sensing signal are received by the communications control unit 604, the speech recognition processing unit 602 may perform speech recognition for the audio signal detected by the microphone array processing unit 601. In particular, for example, when the person detection flag of the person detection information 1500 is “1” and the entry flag of the entry sensing information 900 is “1”, the speech recognition processing unit 602 performs speech recognition for the audio signal.

As a result, unintended operation of a door or lock of the vehicle 130 by a speaker is prevented and the operator is limited to a user carrying the electronic key K, whereby a decrease in security is prevented.

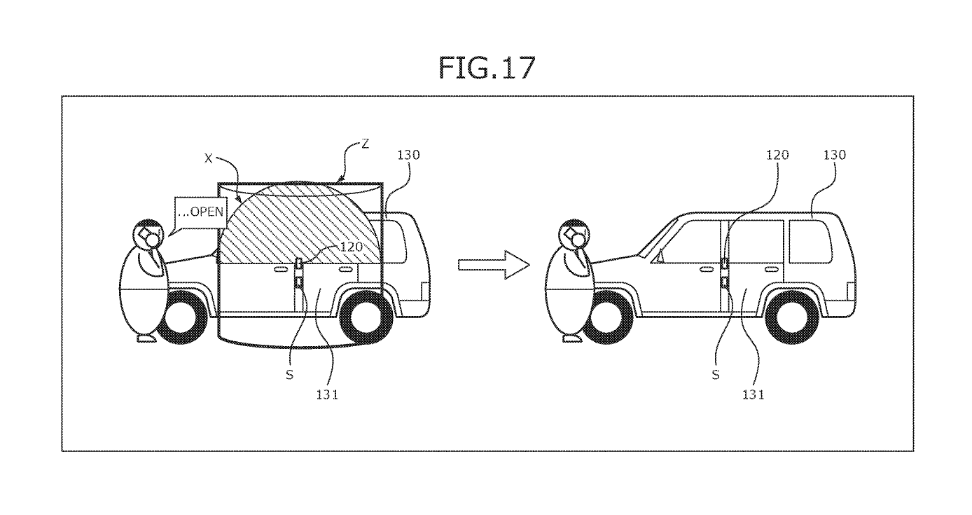

Control by the opening/closing control apparatus 101 according to the third embodiment will be described with reference to FIGS. 16 and 17, taking a case of controlling operations of opening and closing the sliding door 131 of the vehicle 130 as an example.

FIG. 16 is a diagram of an example of control by the opening/closing control apparatus 101 according to the third embodiment. In FIG. 16, a user within the detection range Z of the person detection sensor S is assumed to say “open” within the directivity range X. In this case, since the user is present within the detection range Z, the person detection flag of the person detection information 1500 is “1”.

Therefore, the opening/closing control apparatus 101 detects a speech section and performs speech recognition. The opening/closing control apparatus 101 controls the opening of the sliding door 131, based on the recognition result (open) obtained by the speech recognition. As a result, even when both hands of the user are occupied, the user can open the sliding door 131 of the vehicle 130 by merely entering the detection range Z of the person detection sensor S and saying “open” within the directivity range X.

FIG. 17 is a diagram of another example of control by the opening/closing control apparatus 101 according to the third embodiment. In FIG. 17, a user near the vehicle 130 is assumed to be talking on a cellular telephone and to say “open” during the conversation. In this case, since the user is not within the detection range Z, the person detection flag of the person detection information 1500 is “0”. Therefore, the opening/closing control apparatus 101 does not perform speech recognition.

Thus, unintended operation of the sliding door 131 of the vehicle 130 by a user talking near the vehicle 130 can be prevented.

Various process procedures of the opening/closing control apparatus 101 according to the third embodiment will be described. First, an updating process procedure for the person detection information 1500 depicted in FIG. 15 will be described.

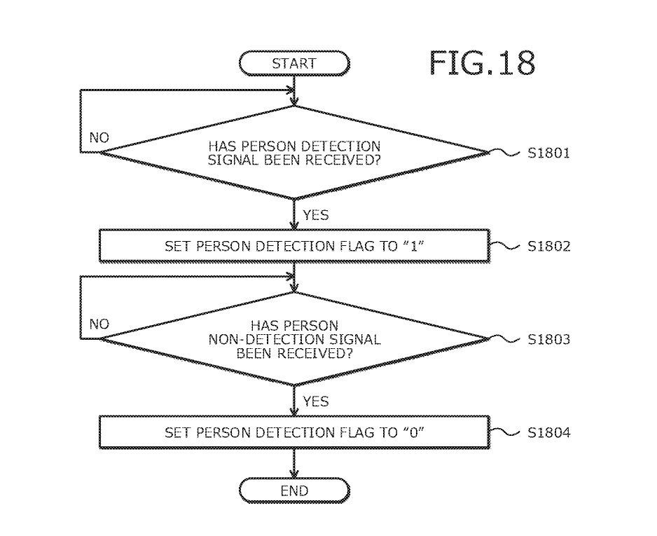

FIG. 18 is a flowchart of an example of the updating process procedure by the opening/closing control apparatus 101 according to the third embodiment. In the flowchart depicted in FIG. 18, the vehicle information recording unit 801 determines whether a person detection signal has been received by the communications control unit 604 (step S1801).

The vehicle information recording unit 801 stands by until a person detection signal is received (step S1801: NO). When a person detection signal is received (step S1801: YES), the vehicle information recording unit 801 sets the person detection flag of the person detection information 1500 to “1” (step S1802).

The vehicle information recording unit 801 determines whether a person non-detection signal has been received by the communications control unit 604 (step S1803). The vehicle information recording unit 801 stands by until a person non-detection signal is received (step S1803: NO).

When a person non-detection signal is received (step S1803: YES), the vehicle information recording unit 801 sets the person detection flag of the person detection information 1500 to “0” (step S1804), ending a series of operations according to the flowchart. Thus, the person detection flag, which indicates whether a person outside the vehicle 130 has been detected by the person detection sensor S disposed on the vehicle 130, is updated.

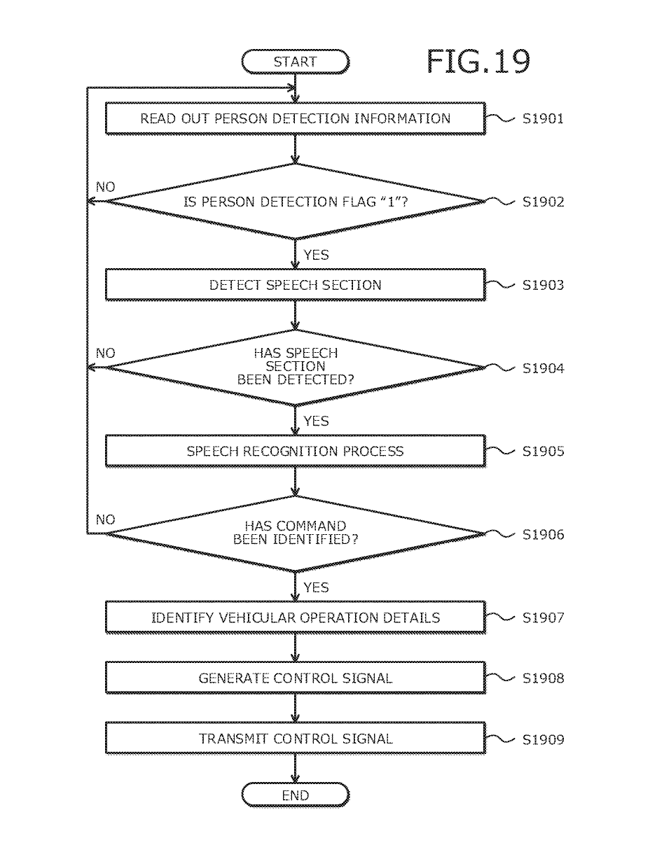

FIG. 19 is a flowchart of an example of the opening/closing control process procedure by the opening/closing control apparatus 101 according to the third embodiment. In the flowchart depicted in FIG. 19, the speech recognition processing unit 602 reads out the person detection information 1500 (step S1901). The speech recognition processing unit 602 determines whether the person detection flag of the person detection information 1500 is “1” (step S1902).

If the person detection flag is “0” (step S1902: NO), the speech recognition processing unit 602 returns to step S1901. If the person detection flag is “1” (step S1902: YES), the speech recognition processing unit 602 analyzes the audio signal detected by the microphone array processing unit 601, the speech recognition processing unit 602 analyzing the audio signal at a constant interval to detect a speech section, (step S1903).

The speech recognition processing unit 602 determines whether a speech section has been detected (step S1904). If a speech section has not been detected (step S1904: NO), the speech recognition processing unit 602 returns to step S1901. If a speech section has been detected (step S1904: YES), the speech recognition processing unit 602 performs speech recognition processing with respect to the audio signal having the detected speech section (step S1905).

The control signal generating unit 603 refers to the command table 500 and identifies a command that corresponds to the speech recognized by the speech recognition processing unit 602, indicated by the recognition result (step S1906). If no command corresponding to the recognition result is identified (step S1906: NO), the control signal generating unit 603 returns to step S1901.

If a command corresponding to the recognition result is identified (step S1906: YES), the control signal generating unit 603 refers to the command table 500 and identifies the vehicular operation details that correspond to the identified command (step S1907). The control signal generating unit 603 generates a control signal corresponding to the identified vehicular operation details (step S1908).

The communications control unit 604 transmits the control signal generated by the control signal generating unit 603 to the operation control unit 610, which controls operations of the vehicle 130 (step S1909), ending a series of operations according to the flowchart.

Thus, when the user is present within the detection range Z of the person detection sensor S, speech recognition for the audio signal detected by the directional microphone 110 can be started.

As described, the opening/closing control apparatus 101 according to the third embodiment enables configuration such that when a person outside the vehicle 130 is detected by the person detection sensor S, speech recognition for an audio signal detected by the directional microphone 110 is performed. Thus, the operator capable of operating vehicular doors and locks by voice activation can be limited to a user detected by the person detection sensor S disposed on the vehicle 130. As a result, even when a person is talking near the vehicle 130, speech recognition is not performed if the person is not detected by the person detection sensor S and therefore, unintended operation of a door or lock of the vehicle 130 by the speaker is prevented.

The opening/closing control method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect, an effect is achieved in that the operator capable of operating vehicular doors and locks by voice activation can be limited.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. An opening/closing control apparatus comprising:
a first directional microphone including a first sound collecting device disposed on a vehicle and configured to collect sound outside the vehicle, the first directional microphone having directivity upward from a horizontal plane that includes a mounting position of the first sound collecting device;
a second directional microphone including a second sound collecting device disposed on the vehicle and configured to collect sound outside the vehicle, the second directional microphone having directivity upward from a horizontal plane that includes a mounting position of the second sound collecting device, the first sound collecting device and the second sound collecting device being aligned vertically with respect to each other;
a microphone array processor configured to detect a temporal difference between a sound collected by the first directional microphone and the sound collected by the second directional microphone and suppress the sound based on the temporal difference being outside a predetermined range to correct an audio signal detected by the first directional microphone and the second directional microphone; and
a control circuit configured to control operation of one of a door and a lock of the vehicle, based on a recognition result obtained by performing speech recognition with respect to the corrected audio signal.

2. The opening/closing control apparatus according to claim 1, wherein
the control circuit performs speech recognition with respect to the corrected audio signal, when entry of an electronic key into an effective range is sensed, the electronic key configured to wirelessly communicate with a communications device of the vehicle.

3. The opening/closing control apparatus according to claim 1, wherein
the control circuit performs speech recognition with respect to the corrected audio signal, when a person outside the vehicle is detected by a person detection sensor disposed on the vehicle.

4. The opening/closing control apparatus according to claim 1, wherein
the door is a sliding door configured to open and close parallel to a body of the vehicle, and
the sound collecting device is disposed at a position at a predetermined height, near the sliding door.

5. A non-transitory, computer-readable recording medium storing therein an opening/closing control program that causes a computer to execute a process comprising:
detecting a temporal difference between a sound collected by a first directional microphone and the sound collected by a second directional microphone and suppressing the sound based on the temporal difference being outside a predetermined range to correct an audio signal detected by the first directional microphone and the second directional microphone, the first directional microphone and the second directional microphone being aligned vertically with respect to each other, the first directional microphone having directivity upward from a horizontal plane that includes a mounting position of a first sound collecting device disposed on a vehicle and configured to collect sound outside the vehicle and the second directional microphone having directivity upward from a horizontal plane that includes a mounting position of a second sound collecting device disposed on the vehicle and configured to collect sound outside the vehicle; and
controlling operation of one of a door and a lock of a vehicle, based on a recognition result obtained by performing speech recognition with respect to the corrected audio signal.

6. An opening/closing control method comprising:
detecting, by a processor, a temporal difference between a sound collected by a first directional microphone and the sound collected by a second directional microphone and suppressing the sound based on the temporal difference being outside a predetermined range to correct an audio signal detected by the first directional microphone and the second directional microphone, the first directional microphone and the second directional microphone being aligned vertically with respect to each other, the first directional microphone having directivity upward from a horizontal plane that includes a mounting position of a first sound collecting device disposed on a vehicle and configured to collect sound outside the vehicle and the second directional microphone having directivity upward from a horizontal plane that includes a mounting position of a second sound collecting device disposed on the vehicle and configured to collect sound outside the vehicle; and
controlling by a computer, operation of one of a door and a lock of a vehicle, based on a recognition result obtained by performing speech recognition with respect to the corrected audio signal.
